(19) United States
(12) Patent Application Publication
(10) Pub. No.: US 2026/0184221 A1
(43) Pub. Date: Jul. 2, 2026

(54) Charging an Electric Vehicle at a Charging Point of a Property

(71) Applicant: Bayerische Motoren Werke Aktiengesellschaft, Muenchen (DE)

(72) Inventor: Jens BERGER, Muenchen (DE)

(21) Appl. No.: 19/130,173

(22) PCT Filed: Nov. 6, 2023
(86) PCT No.: PCT/DE2023/100817

§ 371 Date: May 15, 2025

(30) Foreign Application Priority Data
Nov. 16, 2022 (DE) 10 2022 130 319.5

(51) Int. Cl. B60L 53/64; B60L 53/68; B60L 58/16

(52) U.S. Cl. CPC B60L 53/64; B60L 53/68; B60L 58/16; B60L 2240/662

(57) ABSTRACT

A method for charging an electric vehicle at a charging point, includes transmitting charging parameters from the vehicle to a home energy management system and to an external IT system associated with the vehicle, the home energy management system generating a charging plan for the vehicle based on the charging parameters, usage information, and tariff information of at least one energy supplier, the home energy management system transmitting the charging plan to the external IT system which analyzes it based on an additional charging parameter of the electric vehicle not transmitted to the charging point, and releases the charging plan unchanged, generates a new charging plan, or rejects the charging plan. The electric vehicle is charged using the unchanged charging plan, the new charging plan, or, if the charging plan has been rejected, a previously valid charging plan.

### BACKGROUND AND SUMMARY

The present disclosure relates to a method for charging an electric vehicle at a charging point of a property equipped with a home energy management system, wherein when the electric vehicle is connected to the charging point, charging parameters are transmitted from the electric vehicle to the home energy management system and the home energy management system comprises a charging plan for the electric vehicle based on the charging parameter transmitted from the electric vehicle, usage information of the property and tariff information of at least one energy supplier. The present disclosure also relates to a charging infrastructure for charging an electric vehicle, which is set up for carrying out the method. The present disclosure is in particular advantageously applicable to single-family homes, especially with a wallbox or several wallboxes as charging point(s) as well as in particular with a photovoltaic system.

DE 10 2009 036 816 A 1 discloses a method and a device for controlling charging stations for electric vehicles. To minimize peak power requirements, at least two charging stations are combined into a group, actual charging parameters are exchanged within the charging stations within the group, a load forecast is created for the group depending on at least the actual charging parameters and target charging parameters are determined for the charging stations in the group depending on the load forecast.

DE 10 2013 010 774 A 1 discloses a method for operating a charging station 2 for electric vehicles, in which a maximum rated value for a charging current or a charging power is determined, the determined maximum rated value for the charging current or the charging power is transmitted to an electric vehicle electrically coupled to the charging station, a first time interval is determined as a function of at least the maximum rated value and the electric vehicle is charged at maximum rated value of the charging current during the first time interval. To increase the service life of the charging station a reduced rated value is determined for the charging current and a second time interval, wherein the second time interval determines a duration during which the charging current or the charging power may not exceed the reduced rated value, the reduced rated value is transmitted to the electric vehicle and the electric vehicle is charged during the second time interval with a maximum of the reduced rated value of the charging current or der charging power.

DE 10 2018 202 755 A 1 discloses a method for adapting an electrical power supply to an electrical power demand in an electric power grid at which at least one electrical charging station is operated, wherein in the method a load forecast is generated for at least one motor vehicle by a control device of the grid, which indicates the future charging period in which the motor vehicle is likely to exchange electrical energy with the grid, a time profile of the power demand present in the grid is estimated as a function of the respective load forecast, a time profile of the power supply in the grid is determined and at least one predetermined compensatory measure is triggered for at least one such loading period for which it is recognized that the power supply is less than the estimated power requirement, the power supply being adjusted to the power requirement by the at least one compensatory measure.

US 2017/0136894 A 1 discloses methods, devices, and systems for the communication exchange between a vehicle and a charging system. The communication exchange can comprise charging request messages which are transmitted or received from the vehicle, which define charging details, such as e.g. a charging type, charging locations, charging orientation and/or other information that corresponds to the charging requests for the requesting vehicle. The charging system can respond to the charging request messages, by accepting or rejecting the vehicle charging request. In response to the acceptance of the request message, the charging system provides charging for the vehicle in accordance with the charging details.

US 2017/0140603 A 1 discloses a system for managing vehicle fleets, comprising: a basic management system, which is configured to enable one or more fleet vehicles to receive a vehicle service, wherein the base management system comprises a database, a communication module and an analysis module, the communication module communicating with the one or more fleet vehicles, the analysis module and the database; one or more fleet vehicles, wherein each fleet vehicle comprises a vehicle database and each is configured to receive a charging service and communicate a vehicle charge status to the communication module, at least one fleet service location, which is configured to transmit a billing price to the communication module and provides the billing service at the billing price; wherein the analysis module receives the charging price and determines whether the at least one fleet service location is selected in order to provide the charging service for at least one fleet vehicle that is operated in a defective charge status; wherein at least one fleet vehicle that is operated in a defective status, a charging service is provided by the at least one fleet service location when the analysis module selects the at least one fleet service location.

It is a task of the present disclosure to overcome the disadvantages of the state of the art at least partly and in particular to provide an improved option for bidirectional charging of an electric vehicle at a charging point connected to a home energy grid of a property.

This task is solved in accordance with the features disclosed herein. Preferred embodiments are also disclosed herein.

The task is solved by a method for charging an electric vehicle at a charging point of a property equipped with an energy management system (“home management energy system”), wherein
when the electric vehicle is connected to the charging point, charging parameters are transmitted from the electric vehicle to the home energy management system (hereinafter also referred to as “HEMS”) and to an external IT system, which is associated with the electric vehicle,
the home energy management system at least on the basis of the charging parameters, generates a charging plan for the electric vehicle from usage information of the property and tariff information of at least one energy supplier,
the home energy management system transmits the charging plan to the external IT system,
the external IT system analyses the charging plan based on at least one additional charging parameter of the electric vehicle that was not transmitted to the charging point from the electric vehicle and
on the basis of the result of the analysis, the external IT system releases the charging plan transmitted from the home energy management system unchanged, generates a new charging plan or rejects the charging plan transmitted from the home energy management system,
wherein
if the charging plan is released unchanged, the electric vehicle is charged using the charging plan released unchanged,
if a new charging plan has been generated, the electric vehicle is charged using the new charging plan and/or
if the charging plan has been rejected, the electric vehicle is charged using a previously valid charging plan.

This method has the advantage that a charging plan for an electric vehicle that was generated by the home energy management system (HEMS) can be analyzed by the “external IT system” instance to determine whether the charging plan makes sense or whether it should be replaced by a better charging plan, which has been replaced by the external IT system and during whose generation at least one additional charging parameter of the electric vehicle, which was not transmitted from the electric vehicle to the charging point, has been considered. The external IT system therefore has more charging-relevant information about the electric vehicle than the HEMS and can use this additional information to set up a better charging plan than the home management energy system.

The electric vehicle typically has a drive battery for driving the electric vehicle. The electric vehicle can be, for example, a hybrid vehicle, PHEV, or a fully electrically driven vehicle, BEV. The electric vehicle can be charged via a charging cable and/or inductively. The charging point can be a charging station, e.g. wallbox, or an inductive charging space. One embodiment is that the charging point and the electric vehicle are set up to charge and discharge the traction battery of the electric vehicle, which can also be referred to as “bidirectional charging”, and the charging plan provides for charging and discharging as required. In particular, the drive battery of the electric vehicle can thus be used as an electric buffer storage for the electricity or energy grid (“home energy grid”) of the property controlled by the HEMS during the connection period of the electric vehicle at the charging point, e.g. in the sense of the so-called V2H (“Vehicle-to-Home”) and/or the so-called V2G (“Vehicle-to-Grid”) concept.

The home energy grid is generally connected via an electricity meter at or as a grid connection with a public energy supply grid. It is a further development that the electricity meter is an intelligent electricity meter (so-called “smart meter”) through which in one variant data can also so be transmitted to the property, e.g. on electricity consumption or power flow, e.g. to the HEMS and/or the wallbox. 3. If the electricity meter is in the exclusive possession of the energy supplier or metering point operator, at least one additional local (private) energy measuring device/electricity meter can be provided to inform the property about the current power flow, particularly a measuring device topologically connected in series with the conventional electricity meter.

The charging parameters transmitted from the electric vehicle to the external IT system can also be considered or referred to as charging parameters of a first group of charging parameters or “first” charging parameters. The “additional” charging parameters, which have not been transmitted from the electric vehicle to the charging point and based on which the external IT system analyzes the HEMS charging plan, can also be considered or referred to as charging point parameters of a second group of charging parameters or “second” charging parameters.

It is a further development that the property is a private home, in particular a single-family home.

Typically, electric consumers such as kitchen devices, washing care devices, lamps, media devices, boilers, air conditioning devices, etc. are connected to the home energy grid of the property.

It is a further development that at least one electricity generating device is connected to the home energy grid of the property for generating electrical energy such as photovoltaic system, a wind turbine, and/or a geothermal system, etc.

It is a further development that at least one stationary electrical energy storage unit of the property's home energy grid is connected for buffering electrical energy.

The HEMS is used, in particular, to forecast an energy demand for the home energy grid and thus to optimize that at least one specified goal is particularly well fulfilled, e.g. low procurement costs from the public energy supply grid, an environmentally friendly energy generation, etc. The optimization can already be carried out when an electric vehicle is connected to the home energy grid as a buffer storage, especially for a longer period. For example, the traction battery can then be charged at times when electrical energy can be obtained particularly cheaply from the public energy supply grid and the traction battery can be discharged, e.g. to reduce energy consumption for the home energy grid from the public energy supply grid at times of high electricity prices and/or feed surplus energy from the home energy grid into the public energy supply grid at times when the associated remuneration is high. This optimization or the management of the electric devices connected to the home energy grid can advantageously be carried out particularly effectively if at least one electricity generation facility and at least one stationary electrical energy storage device are available. Possible forecast data used by the HEMS for the optimization can comprise, for example, typical, e.g. daytime-dependent electricity prices when procuring from the and/or feeding into the public energy supply grid, weather forecasts, e.g. electricity consumption forecasts obtained from historical data for the electrical consumers, etc. connected to the home energy grid.

However, the HEMS cannot control the charging and discharging of the drive battery of the electric vehicle completely freely and ad hoc adapted to the needs of the home energy grid, but generates a charging plan (i.e. a planned course of a charging or discharging current between the charging point and the electric vehicle for an connection period of the electric vehicle), which also considers “first” charging parameters of the electric vehicle, which have been transmitted from the electric vehicle to the HEMS, e.g. directly via the radio interface (e.g. LTE or WLAN) or indirectly via the charging point, e.g. by using a ISO 15118-20-conforming data exchange. Such first charging parameters frequently comprise information about a desired or probable point of departure, a charge status desired as the point of departure (“target SoC”) or a corresponding electricity quantity, a charge status not to be fallen short of (“minimum SoC”) and a maximum and/or minimum charging and/or discharging power.

The fact that these charging parameters are transmitted from the electric vehicle to an external IT system can comprise for example that these charging parameters are transmitted from the electric vehicle directly via a functional interface (e.g. LTE or WLAN and additionally via the Internet) or indirectly via the charging point and/or HEMS. It is also possible that some of the charging parameters are already stored in the external IT system linked with a vehicle ID (e.g. the minimum SoC and the maximum and/or minimum charging and/or discharge current) and the vehicle ID is also transmitted to the external IT system along with the departure time and the destination SoC.

In a further development, the fact that the external IT system is “associated” with the electric vehicle means that the external IT system is an IT system distinct from the HEMS, which stores the additional charging parameters of the electric vehicle and additional electric vehicles in a vehicle fleet, and can analyze a charging plan as described above for the electric vehicle in the fleet. The external IT system can, in particular, be an IT system maintained by the manufacturer of the electric vehicle. The external IT system can offer or carry out the analysis, etc., to the HEMS and/or the electric vehicle as a service, and accordingly, be associated as a service provider.

The fact that the electric vehicle is connected to a charging point can comprise that it is connected via a charging cable or inductively at a charging point.

The usage information of the property can in particular comprise a forecast of the energy consumption of the electrical consumer connected to the home energy grid and possibly be a forecast of the electrical power generated by the at least one energy provider connected to the home energy grid and/or capacities of buffer storages etc.

The tariff information of an energy supplier can be transmitted from the energy supplier directly to the HEMS or can be transmitted from the smart meter to the HEMS if a smart meter is available at the grid connection point.

The HEMS can transmit the charging plan directly or indirectly (e.g. through the charging point) to the external IT system.

The external IT system analyzes the charging plan at least on the basis of one additional charging parameter of the electric vehicle, which was not transmitted from the electric vehicle to the charging point, thus at least from charging-relevant additional information via the electric vehicle, which is not available to the HEMS. Then, for example, a new charging plan can be created by the external IT system and compared with the one from the HEMS and then, for example, analyzed to determine which charging plan is more suitable for charging the electric vehicle.

The fact that the external IT system releases the charging plan transmitted from the HEMS unchanged on the basis of the result of the analysis, is particularly relevant when a charging plan generated by the external IT system is or is not essentially more suitable than the charging plan generated by the HEMS. In this case, the external IT system can, for example, either not give any feedback or transmit an explicit release message to the HEMS and/or the charging point.

If the external IT system has determined that a new charging plan generated by it is more suitable than the charging plan generated by the HEMS, e.g. the new charging plan is transmitted to the HEMS and/or the charging point. Whether a new charging plan is generated can also depend on whether or not the charging plan previously created by the HEMS is permitted by the other charging parameters.

The charging plan transmitted by the HEMS can be rejected for example if it is not permitted by the additional charging parameter or if it breaches boundary conditions laid down based on the additional charging point.

It is an embodiment that the at least one additional or second charging parameter comprises at least one parameter from the group comprises:
at least a maximum number of wake-ups of the electric vehicle, in particular its electronics, during the connection period,
maximum frequency of wake-ups of the electric vehicle, in particular its electronics, during the connection period and/or
maximum energy throughput between charging point and electric vehicle during the connection period.

The limitation of the maximum number and/or frequency of wake-ups advantageously limits the load on the vehicle electronics caused by its startup, e.g., from an idle or standby state. Additionally, this advantageously keeps the energy consumption of the vehicle electronics within limits. Wake-ups can occur, for example, when (a) renegotiations regarding a change in the charging plan are carried out with the charging point or the HEMS, (b) the drive battery is charged or discharged. The number and/or frequency of wake-ups must be limited. This can be implemented, for instance, by limiting the number of new charging plans permitted for the electric vehicle during the connection period and/or by restricting the number of charging and discharging phases that follow a dead time specified in the charging plan.

It is an embodiment that the at least one maximum number of wake-ups of the electric vehicle comprises or is a maximum number of wake-ups through renegotiations of charging plans. Renegotiation of loading plans can mean, for example, that a new charging plan has been drawn up (e.g. because particular forecasts such as electricity tariffs have changed since the drafting of the last charging plan) and this charging plan is coordinated or negotiated with the electric vehicle to replace the last charging plan. For this renegotiation, vehicle electronics currently in its rest or standby status must be started up or woken up.

It is an embodiment that the at least one maximum number of wake-ups of the electric vehicle comprises or is a maximum number of wake-ups through charging processes during the implementation of a charging plan.

This limits the number of wake-up processes during the execution of a load plan itself. This takes into account the fact that the charging plan may have charging dead times during which no charging (i.e. charging and discharging) is to be carried out, especially if the vehicle is connected for a long period of time. During these charging dead times, the vehicle electronics are typically in a rest or standby state. This embodiment prevents too frequent switching between charging and non-charging phases.

It is an embodiment that the maximum number of wake-ups up until the departure time of the electric vehicle is indicated, e.g. a maximum of five wake-up phases up until the departure time. Alternatively, or additionally, the maximum number of wake-ups per period, per 8 h, per 12 h or per 24 h can be indicated.

It is a further development that the maximum number of the wake-ups lies between four and ten, in particular between five and seven, in particular at five.

It is a further development that the maximum number of the wake-ups and/or the maximum energy throughput represents the maximum value during a specified timeframe, e.g. the maximum number during a day, a half day or fragments or multiples of a day.

It is a further development that the maximum frequency of the wake-ups lies between one and two per hour, in particular one wake-up per hour.

Limiting the energy throughput between the charging point and the electric vehicle during the connection period is beneficial for the drive battery of the electric vehicle. An energy throughput is in particular understood to be the electrical energy, power or electricity quantity that is exchanged between charging point and electric vehicle without consideration of the current direction.

It is an embodiment that at least one of the additional charging parameters is dependent on a state of health (also as SoH, “State-of-Health”) of the drive battery of the electric vehicle. This helps to further protect the vehicle components under load during charging, especially the traction battery itself. Thus, for example, if a SoH of the drive battery is comparatively low (e.g. due to its age, a higher number of quick charging processes etc.) the maximum energy throughput is reduced.

Additionally or alternatively to the state of health, at least one of the additional or second charging parameters is dependent on at least one influencing variable, e.g., age or vehicle electronics, external temperature, hardware and/or software updates carried out, and/or user behavior of the electric vehicle user, etc. To provide the other influencing parameters and possibly influencing variables, it is particularly advantageous if the external IT system is an IT system of the electric vehicle manufacturer, since the manufacturer has particularly high technical competence for determining and possibly also changing/updating at least one additional charging parameter.

It is an embodiment that the new charging point generated by the external IT system is transmitted by the external IT system to the HEMS and from the HEMS to the charging point.

It is an embodiment that the new charging plan generated by the external IT system can be rejected by the HEMS. This has the advantage that the electric vehicle can be prevented from being charged according to a charging plan that is disadvantageous or undesirable for the operator of the property, e.g. the homeowner. This configuration can include that the new charging plan created by the external IT system can be automatically rejected by the HEMS. Alternatively, the charging plan can be accepted or rejected by the operator of the property upon request (e.g. through the user terminal device). It is a further development that the external IT system presents the charging plan generated by them to the operator for acceptance or rejection (e.g. through a user terminal device) and transmits it only after acceptance to the HEMS, which is then either bound to acceptance by the operator of the property or can nevertheless reject the new loading plan.

It is an embodiment that the new charging plan generated from the external IT system is transmitted to the charging point from the external IT system. The charging point can then charge the electric vehicle in accordance with the new charging plan, i.e., selectively charge or discharge it. In a further development, confirmation by the HEMS is not required. This embodiment can even be implemented such that the HEMS is not informed about the new charging plan.

It is an embodiment that the HEMS generates a charging plan for the electric vehicle at different times during the connection period. This is advantageous in order to be able to consider changed boundary conditions that were used when the previous loading plan was generated. Such changed boundary conditions can for example comprise changed electricity tariffs, a changed weather forecast etc. With each charging plan generated by the HEMS the method can be throughput again.

It is an embodiment that the first charging plan transmitted during the connection period from the HEMS to the external IT system cannot be rejected by the external IT system. Thus, it is advantageously ensured that the electric vehicle is charged.

It is an embodiment that the external IT system maintains at least one proprietary electricity tariff and additionally analyses and releases, newly generates, or rejects the charging plan based on the at least one proprietary electricity tariff. Better electricity tariffs can possibly be provided advantageously through the external IT system as only through the HEMS, for example, because the external IT system with its many electric vehicles supported by it possibly has a better market position and / or wider tariff selection than the HEMS. In particular, the external IT system can then provide the proprietary electricity tariff with the new charging plan to the HEMS and/or charging point, possibly for a fee. The “proprietary” electricity tariff is thus in particular an electricity tariff, which is made available to the external IT system for charging the associated electric vehicle, but not to the HEMS. In particular, a “proprietary” electricity tariff can be an electricity tariff especially negotiated by the external IT system. The external IT system can purchase the proprietary electricity tariff on energy markets, grid system service markets for grid stabilization, etc., for example.

The task is also solved by a charging infrastructure for charging an electric vehicle, which is set up for carrying out the method described above. The charging infrastructure can be designed analogously to the method, and vice versa, and has the same advantages.

It is an embodiment that die charging infrastructure comprises:
a property with a home energy grid, which is connected via a grid connection point to a public energy supply grid and which comprises at least one charging point set up for the bidirectional charging of electric vehicles, which can receive charging point parameters from an electric vehicle connected to it,
A HEMS, that is set up to control at least one electric buffer storage connected to the home energy grid based on electricity usage information in the home energy grid and from tariff information regarding the electrical energy flowing through the grid connection and which furthermore is set up to use an electric vehicle connected at the at least one charging point as buffer storage of the home energy grid and generate a charging plan for controlling the bidirectional charging of the electric vehicle
an external IT system communicatively coupled with the HEMS that is set up to analyze a charging plan generated by the HEMS based on at least one additional charging parameter of the electric vehicle, which was not transmitted from the electric vehicle to the charging point and release the charging plan transmitted from the home energy management system unchanged, generate a new charging plan or reject the charging plan transmitted from the home energy management system, on the basis of the result of the analysis,
   wherein
if the charging plan is released unchanged, the electric vehicle is chargeable using the charging plan released unchanged,
if the charging plan has been modified, the electric vehicle is chargeable using the new charging plan and
if the charging plan has been rejected, the electric vehicle is chargeable using a previously valid charging plan.

It is an embodiment in which the home energy management system is an independent component of the charging infrastructure. It can, for example, be implemented on a data processing facility of the property or the home energy grid, e.g., through corresponding programming. The home energy management system, however, can also be an internal instance regarding the property, e.g. which is communicatively coupled with the property, e.g. a grid server or a cloud calculator.

It is an embodiment that the home energy management system is integrated into the charging point. The charging point then comprises the function(s) of the home management energy systems.

It is an embodiment that the charging infrastructure includes a smart meter at the grid connection point, and that the home energy management system is integrated into the smart meter. The smart meter can then, for example, generate a charging plan and transmit it to the wallbox.

The properties, features and advantages of the present disclosure described above as well as the way in which these are achieved become clearer and more clearly understandable in connection with the following schematic description of an embodiment, which is explained in detail in connection with the drawings.

### BRIEF DESCRIPTION OF THE DRAWINGS

FIG. 1 shows a sketch of a charging infrastructure for charging an electric vehicle; and

FIG. 2 shows a simplified possible process for charging an electric vehicle using the charging infrastructure shown in FIG. 1.

### DETAILED DESCRIPTION OF THE DRAWINGS

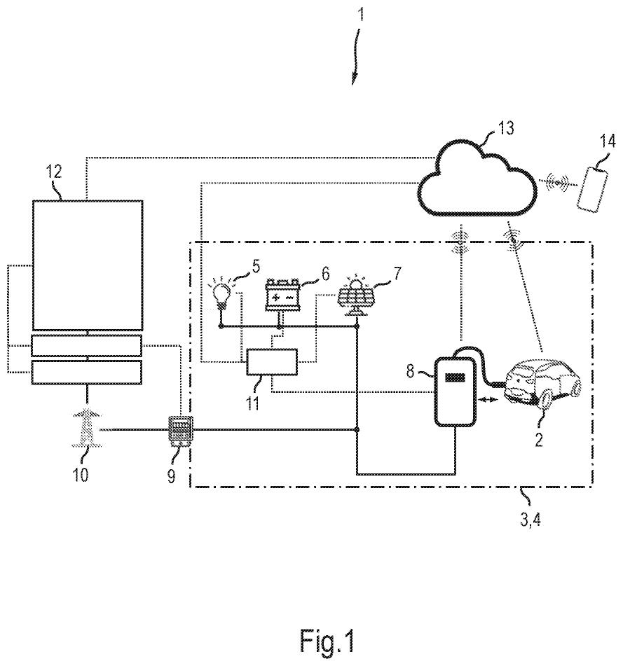

FIG. 1 shows a sketch of a charging infrastructure 1 for charging an electric vehicle 2. The charging infrastructure 1 comprises a property, in this example a detached house 3, with a home energy grid 4 for supplying electrical consumers 5 with electricity. A photovoltaic system 6, a stationary electrical buffer storage unit 7 and a charging point in the form of a wallbox 8 are also integrated into the home energy grid 4. In a further development, the buffer storage unit 7 can be integrated into the photovoltaic system 6.

The home energy grid 4 is connected to a public electricity grid or energy supply grid 10 via a measuring point or grid connection point in the form of a so-called “smart meter”9. The electric vehicle 2 can be connected to the wallbox 8 for charging. If the electric vehicle 2 is connected to the wallbox 8, it can serve as a buffer storage device for the home energy grid 4 within certain charging parameters and can be charged and discharged accordingly. The wallbox 8 and the electric vehicle 2 can exchange data, for example, via ISO 15118-20.

In particular, the wallbox 8 can receive charging parameters from the electric vehicle 2 such as a battery capacity, a specified or estimated departure time, a target SoC at the time of departure, a maximum charging power, a minimum SoC to be maintained, etc.

The home energy grid 4 also comprises a home energy management system or HEMS 11, which is set up to control a charging and discharging process of the buffer storage unit 7 and the traction battery of the electric vehicle 2, which acts as a buffer storage unit when connected. The HEMS 11 is connected by data technology to, if possible, at least one of the loads 5, the photovoltaic system 6, the stationary buffer storage unit 7 and the wallbox 8, as indicated by the dotted lines. The HEMS 11 can also receive its charging parameters via the wallbox 8 or directly from the electric vehicle 2.

If, as assumed in this example, the grid connection point is a smart meter 9, the HEMS 11 can also be connected to it in terms of data technology. However, other data technology topologies can also be implemented in principle: for example, the smart meter 9 can be connected to the wallbox 8 in terms of data technology. A private meter belonging to the single-family home 3 can also be used instead of a smart meter 9.

The HEMS 11 is also connected to at least one participant in an electricity market 12, such as at least one energy supplier, which energy supplier offers electricity to the home energy grid 4 in accordance with a specific-possibly time-variable-electricity tariff for purchase from the energy supply grid 10 and also sets feed-in prices for feeding surplus electrical energy from the home energy grid 4 into the energy supply grid 10. The tariff information can be transmitted to the HEMS 11 by the participant in the electricity market 12 or by the smart meter 9. The participants of the electricity market 12 can include, for example, energy suppliers, energy aggregators, energy markets, grid system service markets, external market participants, etc. These participants can, for example, cooperate with grid operators and metering point operators.

On the basis of a forecast of consumption in the home energy grid 4, a forecast of energy generation by the photovoltaic system 6 (e.g. also using weather forecasts) and the tariff information transmitted by the electricity market participant 12, the HEMS 11 can (e.g. also using weather forecasts) and the tariff information transmitted by the electricity market participant 12, the HEMS 11 set up a charging plan (comprising charging and discharging) for the intermediate storage unit 7 and the electric vehicle 2 up to the expected departure time in order to influence the flow of electricity through the smart meter 9 to optimize at least one predetermined purpose, e.g. for cost optimization. The charging plan generated by the HEMS 11 for the electric vehicle 2 (hereinafter also referred to as the “HEMS charging plan”) also considers the charging parameters transmitted by the electric vehicle 2 as charging boundary conditions. The charging plan for the electric vehicle 2 may, for example, be transmitted to the wallbox 8 from the HEMS 11, which then executes this charging plan together with the electric vehicle 2.

In the present case, the charging infrastructure 1 also has an external IT system 13 or is communicatively coupled with an external IT system 13, which is set up to analyze the HEMS charging plan generated by the HEMS 11 at least on the basis of one additional charging parameter of the electric vehicle 2, which is known to the external IT system 13 but was not transmitted from the electric vehicle 2 to the wallbox 8. For this purpose, the HEMS charging plan is transmitted to the external IT system 13 before the analysis is carried out, e.g. directly from the HEMS 11 or via the wallbox 8. On the basis of the result of the analysis, the external IT system 13 can release the HEMS charging plan unchanged, generate a new charging plan (hereinafter also referred to as EIS (“external IT system”) charging plan without limiting the generality) or reject the HEMS charging plan. The at least one additional charging parameter can be at least one parameter from the group: maximum number of wake-ups of the electric vehicle during the connection period, maximum frequency of wake-ups of the electric vehicle during the connection period and/or maximum (bidirectional) energy throughput between wallbox 8 and electric vehicle 2 during the connection period. At least one of these additional charging parameters can be dependent on the state of health of a drive battery of the electric vehicle 2, its temperature, an ambient temperature etc.

In addition, the external IT system 13 may maintain at least one proprietary electricity tariff that is not available for the HEMS 11 and additionally analyze and release, change, or reject the EIS charging plan based on the at least one proprietary electricity tariff. This proprietary electricity tariff may, for example, have been purchased from the external IT system and made available to such home energy grids 4 that have a corresponding contractual relationship with the external IT system 13.

The external IT system 13 can, for example, be an IT system maintained or operated by the manufacturer of the electric vehicle 2. It can also include grid servers and/or be cloud-based. The external IT system 13 can be connected directly to the electric vehicle 2, the wallbox 8, and/or a user terminal 14, such as a mobile user terminal (e.g., a smartphone or tablet PC), via data technology, e.g., wirelessly.

If the HEMS charging plan is released unchanged by the external IT system 13, this can be communicated to the HEMS 11 and/or the wallbox 8, and the electric vehicle 2 is then charged and, if necessary, discharged using the unchanged released HEMS charging plan.

If an EIS charging plan has been generated by the external IT system 13, which differs from the HEMS charging plan, the EIS charging plan can be transmitted directly to the wallbox 8 or firstly to the HEMS 11 and then to the wallbox 8 from the HEMS 11. The electric vehicle 2 is then charged and, if necessary, discharged using the EIS charging plan.

If the HEMS charging plan has been rejected, the electric vehicle 2 will be charged using the previously valid charging plans implemented prior to the rejected HEMS charging plan.

It is possible in a further development that the EIS charging plan generated by the external IT system 13 is rejected by the HEMS 11, e.g. because it violates the homeowner's specifications.

In a further development, it is possible that the first HEMS charging plan transmitted by the HEMS 11 to the external IT system 13 during the connection period of the electric vehicle 2 cannot be rejected by the external IT system 13, but only the second, third etc. HEMS charging plan transmitted to the external IT system 13, for example.

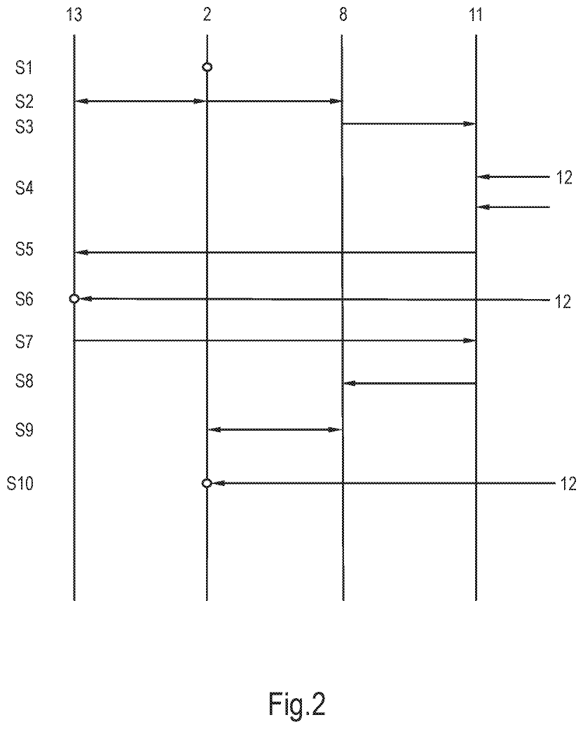

FIG. 2 shows a simplified possible process for charging an electric vehicle 2 using the charging infrastructure 1 shown in FIG. 1.

In Step S1, the electric vehicle 2 is connected to the wallbox 8 via a charging cable, for example.

Then, in Step S2, the electric vehicle 2 transmits charging parameters such as an estimated departure time, a target SoC at departure time, a minimum SoC, etc. to the wallbox 8 and the external IT system 13. In Step S3, the charging parameters-possibly with additional information such as a charging mode selected by the wallbox 8, etc.-are additionally transmitted to the HEMS 11. Alternatively, the charging parameters can be transmitted directly to the HEMS 11 by the wallbox 8 in Step S2.

In Step S4, the HEMS 11 receives tariff and power specifications (envelope curve) for energy consumption and feed-in from one of the participants in the electricity market 12, such as an energy supplier.

In Step S5, the HEMS 11 generates a HEMS charging plan for the electric vehicle 2 and transmits it to the external IT system 13.

In Step S6, the external IT system 13 analyzes the HEMS charging plan and responds to it, e.g., by releasing or generating an EIS charging plan.

In Step S7, the reaction of the external IT system 13 is transmitted to the HEMS 11. If, for example, the HEMS charging plan is to be released, this can be done directly by transmitting a corresponding release message to the HEMS 11 from the external IT system 13 or indirectly via a non-reaction within a predefined period of time (e.g. in the sense of a timeout).

In Step S8, the (directly or indirectly) released HEMS charging plan or the new EIS charging plan is transmitted to the wallbox 8 from the HEMS 11. Alternatively, the released HEMS charging plan or the new EIS charging plan can be transmitted directly to the wallbox 8 from the external IT system 13, with or without notifying the HEMS 11.

In Step S9, the electric vehicle 2 is now charged at the wallbox in accordance with the HEM charging plan or the EIS charging plan.

In Step S10, the HEMS 11 generates a new HEMS charging plan analogous to Step S5, e.g. in the event of a change in the tariff and power specifications and/or forecasts such as a weather forecast, etc. Steps S6 to S9 can then be run through again, wherein in Step S6 the new HEMS charging plan can now also simply be rejected by the external IT system 13, for example because a maximum number of wake-ups of the electric vehicle 2 has been reached and implementing a new charging plan would lead to the electric vehicle being woken up.

Of course, the present disclosure is not limited to the embodiments shown.

It is therefore a further development that a user is informed of a charging plan to be implemented for charging. It is a further development that a user can accept and/or reject a charging plan, in particular a new charging plan. In a further development, a user can also confirm an automatically estimated departure time, specify a departure time themself and/or postpone a departure time.

### LIST OF REFERENCE SIGNS

1 Charging infrastructure
2 Electric vehicle
3 Single-family home
4 Home energy grid
5 Electrical load
6 Photovoltaic system
7 Electric buffer storage
8 Wallbox
9 smart meter
10 Energy supply grid
11 Home energy management system
12 Electricity market
13 External IT system
14 User terminal
S1-S10 Method steps

1-14. (canceled)

15. A method for charging an electric vehicle at a charging point of a property equipped with a home energy management system, the method comprising:
transmitting charging parameters from the electric vehicle to the home energy management system and to an external IT system that is associated with the electric vehicle when the electric vehicle is connected to the charging point;
generating, by the home energy management system, a charging plan for the electric vehicle at least on a basis of the charging parameters transmitted by the electric vehicle, usage information of the property, and tariff information of at least one energy supplier;
transmitting, by the home energy management system, the charging plan to the external IT system;
analyzing, by the external IT system, the charging plan on a basis of at least one additional charging parameter of the electric vehicle that was not transmitted to the charging point from the electric vehicle; and
at least one of, on a basis of a result of the analysis:
releasing, by the external IT system, the charging plan transmitted by the home energy management system unchanged, and charging the electric vehicle using the charging plan that was released unchanged;
generating, by the external IT system, a new charging plan, and charging the electric vehicle using the new charging plan; or
rejecting, by the external IT system, the charging plan transmitted by the home management energy system, and charging the electric vehicle using a previously valid charging plan.

16. The method according to claim 15,
wherein the at least one additional charging parameter is at least one of:
at least a maximum number of wake-ups of the electric vehicle during a connection period,
a maximum frequency of wake-ups of the electric vehicle during of the connection period, and/or
a maximum energy throughput between the charging point and the electric vehicle during the connection period.

17. The method according to claim 16,
wherein at least one of the at least one additional charging parameter is dependent on a state of health of a drive battery of the electric vehicle, an age of the vehicle electronics, an outside temperature, and/or a user behavior of a user of the electric vehicle.

18. The method according to claim 15, comprising:
transmitting the new charging plan generated by the external IT system to the home energy management system from the external IT system, and to the charging point from the home management energy system.

19. The method according to claim 15, comprising:
rejecting, by the home management energy system, the new charging plan generated by the external IT system.

20. The method according to claim 15, comprising:
transmitting, by the external IT system, the new charging plan generated by the external IT system to the charging point.

21. The method according to claim 15, comprising:
generating, by the home energy management system, charging plans for the electric vehicle at different times during the connection period.

22. The method according to claim 15,
wherein the charging plan transmitted to the external IT system from the home energy management system during the connection period cannot be rejected by the external IT system.

23. The method according to claim 15, comprising:
maintaining, by the external IT system, at least one proprietary electricity tariff; and
analyzing, by the external IT system, the charging plan on a basis of the at least one proprietary electricity tariff.

24. The method according to claim 15,
wherein the external IT system is an IT system maintained by a manufacturer of the electric vehicle.

25. A charging infrastructure for charging an electric vehicle, comprising:
at least one charging point configured to perform bidirectional charging of electric vehicles and receiving charging parameters from an electric vehicle connected to it, wherein the at least one charging point is connected to a home energy grid, which is connected to a public power supply grid via a grid connection point;
a home energy management system configured to:
control at least one electric buffer storage device connected to the home energy grid on a basis of electricity usage information in the home energy grid and tariff information relating to electrical energy flowing via the grid connection point;
use an electric vehicle connected to the at least one charging point as a buffer storage device of the home energy grid; and
generate a charging plan for controlling the bidirectional charging of the electric vehicle; and
an external IT system communicatively coupled with the home energy management system, and configured to:
analyze the charging plan generated by the home energy management system at least on a basis of one additional charging parameter of the electric vehicle, which was not transmitted to the charging point from the electric vehicle; and
on a basis of a result of the analysis, at least one of:
release the charging plan transmitted by the home energy management system unchanged,
generate a new charging plan, or
reject the charging plan transmitted by the home energy management system;
wherein:
if the external IT system releases the charging plan unchanged, the electric vehicle can be charged using the charging plan which was released unchanged,
if the external IT system generates the new charging plan, the electric vehicle can be charged using the new charging plan, and
if the external IT system rejects the charging plan, the electric vehicle can be charged using a previously valid charging plan.

26. The charging infrastructure according to claim 25, wherein the home energy management system is an independent component of the charging infrastructure.

27. The charging infrastructure according to claim 25, wherein the home energy management system is integrated into the charging point.

28. The charging infrastructure according to claim 25, wherein the charging infrastructure at the grid connection point comprises a smart meter, and the home energy management system is integrated into the smart meter.
